(19) United States
(12) Patent Application Publication
(10) Pub. No.: US 2009/0256898 A1
(43) Pub. Date: Oct. 15, 2009

(54) Device for printing a picture onto a piece of cloth to be embroidered, and embroidering machine having the same

(75) Inventor: Shui-Chun Tseng, Taichung Hsien (TW)

Correspondence Address: Intellectual Property Law Office of David Lathrop, No. 827, 39120 Argonaut Way, Fremont, CA, 94538, US

(73) Assignee: Zeng Hsing Industrial Co., Ltd., Taiping City (TW)

(21) Appl. No.: 12/082,331

(22) Filed: Apr. 9, 2008

(51) Int. Cl. D05C 7/00; B41J 3/407; D05C 9/00; D05C 3/00

(52) U.S. Cl. 347/106; 347/2; 112/78; 112/470.14

(57) ABSTRACT

A printing device includes a cloth-holding frame unit mounted fittingly and detachably in a receiving groove in a base, and having a lock bolt for locking an outer frame on a looped inner frame disposed on and surrounded by the outer frame such that a piece of cloth is held tensionally between the inner and outer frames. A cover is connected pivotally to the base for covering the receiving groove in the base, and is configured with an inner accommodating space in spatial communication with the receiving groove in the base. A coloring unit is mounted on the cover, is disposed movably in the inner accommodating space in the cover and above the piece of cloth, and is operable so as to spray a coloring material onto the piece of cloth, thereby printing a picture onto the piece of cloth with the coloring material sprayed from said coloring unit.

### BACKGROUND OF THE INVENTION

1. Field of the Invention

The invention relates to a printing device, more particularly to a device for printing a picture onto a piece of cloth to be embroidered, and an embroidering machine having the same.

2. Description of the Related Art

FIG. 1 illustrates a conventional embroidering machine 200 that includes a housing unit 210 and a stitching unit 220. In addition, a base 300 is connected to a lateral side of the housing unit 210, and is mounted with a slide seat 310 for clamping a cloth-holding frame 320 thereon. The cloth-holding frame 320 is used for holding tensionally a piece of cloth that has been printed with a picture thereon. It is noted that the picture printed onto the piece of cloth is formed using a conventional color pressing mechanism. Thus, the piece of cloth is first formed with the picture through the color pressing operation, and is then attached to the cloth-holding frame 320 to perform embroidering operation.

However, since the piece of cloth is tensioned by the cloth-holding frame 320 with a tension degree suitable for the embroidering operation and different from that suitable for the color pressing operation, the picture presented on the piece of cloth may differ slightly from that formed on the piece of cloth through the color pressing operation due to different tension degrees, thereby resulting in picture distortion.

### SUMMARY OF THE INVENTION

Therefore, the object of the present invention is to provide a device for printing a picture onto a piece of cloth to be embroidered that includes a cloth-holding frame unit suitable for an embroidering machine and that that can overcome the aforesaid drawbacks of the prior art.

According to one aspect of the present invention, there is provided a device for printing a picture onto a piece of cloth. The device comprises:

a base having a top surface formed with a receiving groove;

a cover connected pivotally to the base, disposed on the top surface of the base for covering the receiving groove, and configured with an inner accommodating space in spatial communication with the receiving groove in the base;

a cloth-holding frame unit adapted for holding the piece of cloth thereon, and mounted fittingly and detachably in the receiving groove in the base, the cloth-holding frame unit having an outer frame disposed in the receiving groove in the top surface of the base, a looped inner frame disposed on and surrounded by the outer frame, and a lock bolt for locking the outer frame on the looped inner frame such that the piece of cloth is held tensionally between the looped inner frame and the outer frame; and

a coloring unit mounted on the cover, disposed movably in the inner accommodating space in the cover and above the piece of cloth, and operable so as to spray a coloring material onto the piece of cloth, thereby printing the picture onto the piece of cloth with the coloring material sprayed from the coloring unit.

According to another aspect of the present invention, there is provided a device for printing a picture onto a piece of cloth. The device comprises:

a base having a top surface;

a coloring mechanism mounted on the top surface of the base, and including a coloring unit disposed above the top surface of the base and movable relative to the base in a first direction;

a slide seat mounted on the top surface of the base, and movable relative to the base in a second direction perpendicular to the first direction; and

a cloth-holding frame unit adapted for holding the piece of cloth thereon, mounted on the slide seat, and disposed below the coloring unit, the cloth-holding frame unit having an outer frame mounted on the slide seat, a looped inner frame disposed on and surrounded by the outer frame, and a lock bolt for locking the outer frame on the looped inner frame such that the piece of cloth is held tensionally between the looped inner frame and the outer frame.

The coloring unit is operable so as to spray a coloring material onto the piece of cloth, thereby printing the picture onto the piece of cloth with the coloring material sprayed from the coloring unit.

According to a further aspect of present invention, an embroidering machine comprises:

a housing unit including a bed portion having a top surface, an upright column portion extending upwardly from the top surface of the bed portion and having a top end, and an arm portion extending laterally from the top end of the column portion to confront the bed portion and having a head disposed above the bed portion;

a stitching unit mounted on the head of the arm portion of the housing unit; and

a device for printing a picture onto a piece of cloth, the device including
a base connected to the bed portion of the housing unit and having a top surface co-planar with the top surface of the bed portion of the housing unit,
a coloring mechanism mounted on the top surface of the base, and including a coloring unit disposed above the top surface of the base and movable relative to the base in a first direction,
a slide seat mounted movably on the top surface of the base and the top surface of the bed portion of the housing unit and operable so as to move in a second direction perpendicular to the first direction within one of a printing area, where the slide seat is disposed on the top surface of the base, and a stitching area, where the slide seat is disposed on the bed portion of the housing unit and below the stitching unit, and
a cloth-holding frame unit adapted for holding the piece of cloth thereon, mounted on the slide seat, and disposed below the coloring unit, the cloth-holding frame unit having an outer frame mounted on the slide seat, a looped inner frame disposed on and surrounded by the outer frame, and a lock bolt for locking the outer frame on the looped inner frame such that the piece of cloth is held tensionally between the looped inner frame and the outer frame.

The coloring unit is operable so as to spray a coloring material onto the piece of cloth when the slide seat is disposed in the printing area, thereby printing the picture onto the piece of cloth with the coloring material sprayed from the coloring unit.

The stitching unit is operable so as to perform embroidery operation on the piece of cloth held on the cloth-holding frame unit and printed with the picture thereon after the slide seat is moved from the printing area into the stitching area.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a conventional embroidering machine;

FIG. 2 is a schematic partly sectional view showing the first preferred embodiment of a device for printing a picture onto a piece of cloth according to the present invention;

FIG. 3 is an exploded, partly cutaway, perspective view showing a cloth-holding frame unit of the first preferred embodiment;

FIG. 4 is a schematic top view showing the second preferred embodiment of a device for printing a picture onto a piece of cloth according to the present invention;

FIG. 5 is a fragmentary schematic sectional view showing the second preferred embodiment;

FIG. 6 is a perspective view showing a slide seat of the second preferred embodiment; and

FIG. 7 is a schematic view showing the second preferred embodiment incorporated with an embroidering machine.

### DETAILED DESCRIPTION OF THE PREFERRED EMBODIMENTS

Before the present invention is described in greater detail, it should be noted that like elements are denoted by the same reference numerals throughout the disclosure.

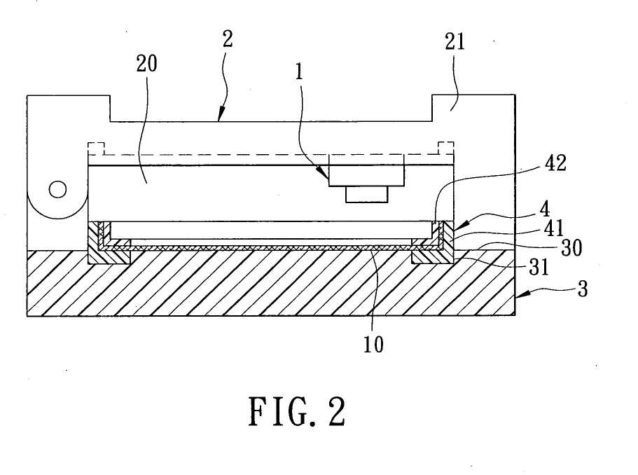

Referring to FIG. 2, the first preferred embodiment of a device for printing a picture onto a piece of cloth 10 according to the present invention is shown to include a base 3, a cover 2, a cloth-holding frame unit 4, and a coloring unit 1.

The base 3 has a top surface 30 formed with a receiving groove 31.

The cover 2 is connected pivotally to the base 3, is disposed on the top surface 30 of the base 3 for covering the receiving groove 31, and is configured with an inner accommodating space 20 in spatial communication with the receiving groove 31 in the base 3.

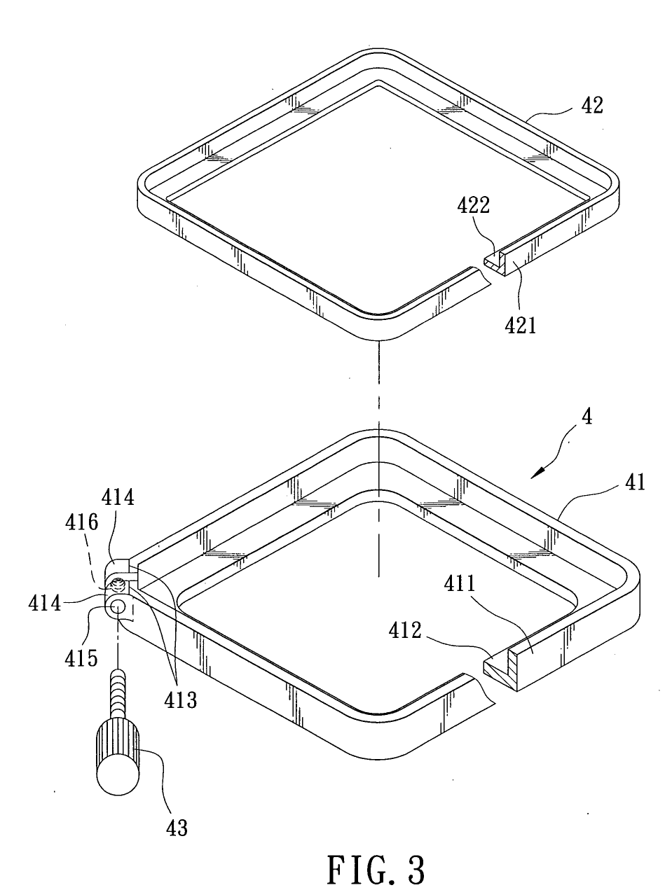

The cloth-holding frame unit 4 is adapted for holding the piece of cloth 10 thereon, and is mounted fittingly and detachably in the receiving groove 31 in the base 3. The cloth-holding frame 4 has an outer frame 41 disposed in the receiving groove 31 in the top surface 30 of the base 3, a looped inner frame 42 disposed on and surrounded by the outer frame 41, and a lock bolt 43 for locking the outer frame 41 on the looped inner frame 42 such that the piece of cloth is held tensionally between the looped inner frame 42 and the outer frame 41. In this embodiment, referring further to FIG. 3, the outer frame 41 is L-shaped in cross section, and has a looped bottom frame portion 412, and an open surrounding frame portion 411 extending upwardly from a periphery of the looped bottom frame portion 412 and having opposite ends 413 separated from each other, and two parallel extensions 414 extending respectively the opposite ends 413 and formed respectively with a through hole 415 and a thread hole 416. The looped inner frame 42 is L-shaped in cross section, and has a looped bottom frame portion 422 disposed on the looped bottom frame portion 412 of the outer frame 41, and a looped surrounding frame portion 421 extending upwardly from a periphery of the looped surrounding frame portion 422 and surrounded by the open surrounding frame portion 411 of the outer frame 41. The lock bolt 43 extends through the through hole 415 in a corresponding one of the extensions 414, and engages the thread hole 416 in the other one of the extensions 414.

The coloring unit 1 is mounted on the cover 2, is disposed movably in the inner accommodating space 20 in the cover 2 and above the piece of cloth 10, and is operable so as to spray a coloring material onto the piece of cloth 10, thereby printing the picture onto the piece of cloth 10 with the coloring material sprayed from the coloring unit 1. Since the feature of the invention does not reside in the configuration of the coloring unit 1, which is conventional, details of the same are omitted herein for the sake of brevity.

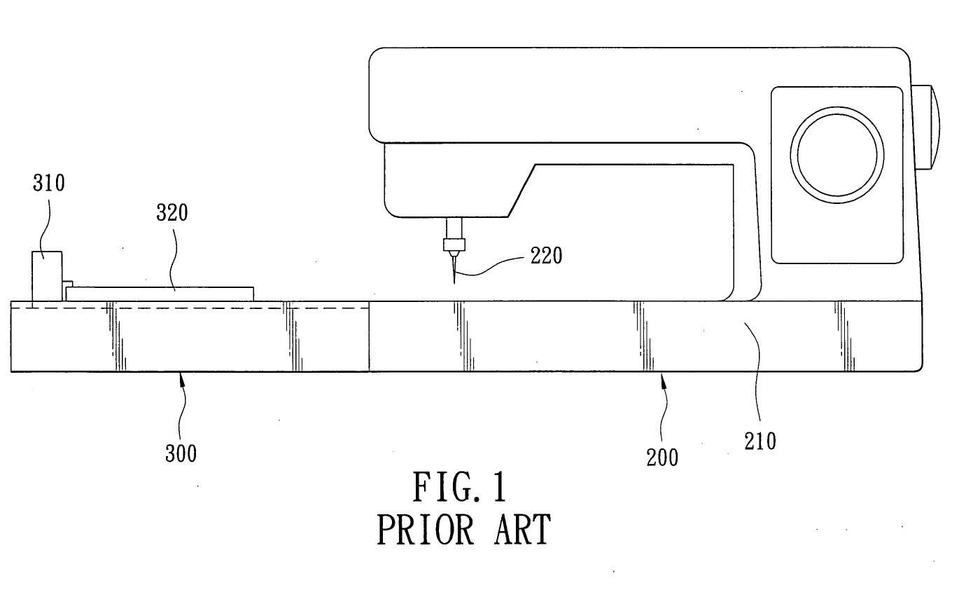

It is noted that, after the printing operation, an assembly of the cloth-holding frame unit 4, and the piece of cloth 10 printed with the picture can be detached from the base 3, and can be then installed on an embroidering machine, such as the conventional embroidering machine shown in FIG. 1, to proceed to embroidering operation. As a result, distortion of the picture printed onto the piece of cloth 10 as encountered in the prior art can be avoided.

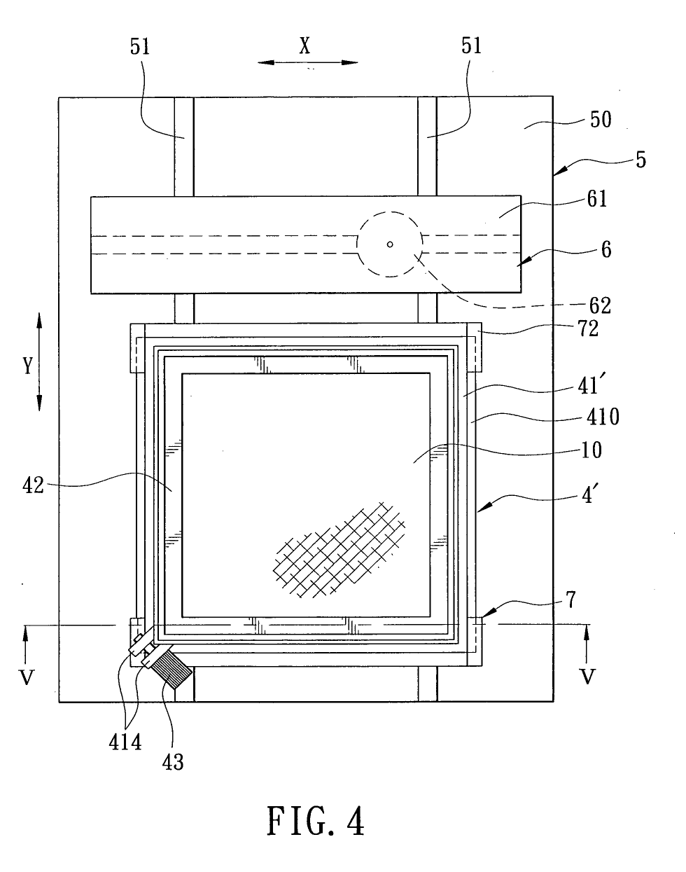

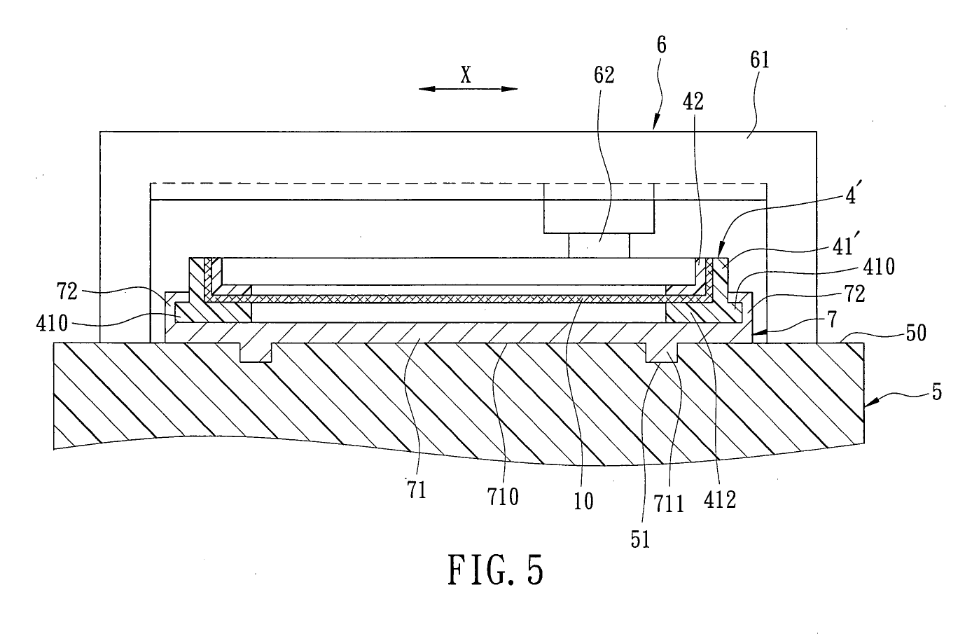

Referring to FIGS. 4 and 5, the first preferred embodiment of a device for printing a picture onto the piece of cloth 10 according to the present invention is shown to include a base 5, a coloring mechanism 6, a slide seat 7, and a cloth-holding frame unit 4′.

The base 5 has a top surface 50. In this embodiment, the top surface 50 is formed with two parallel slide slots 50 opposite to each other in a first direction (X) and extending in a second direction (Y) perpendicular to the first direction (X).

The coloring mechanism 6 is mounted on the top surface 50 of the base 5, and includes an inverted U-shaped mounting frame 61 and a coloring unit 62. The inverted U-shaped mounting frame 61 is mounted fixedly on the top surface 50 of the base 5, and is disposed across the slide slots 50. The coloring unit 62 is mounted on the mounting frame 61, is disposed above the top surface 50 of the base 5, and is movable relative to the base 5 in the first direction (X).

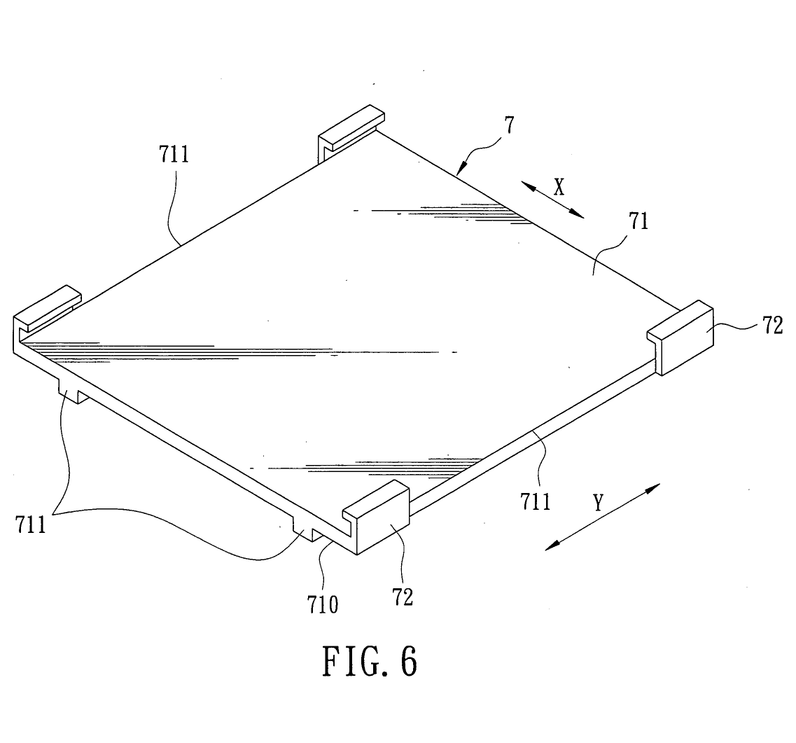

The slide seat 7 is mounted on the top surface 50 of the base 5, and is movable relative to the base 5 in the second direction (Y). In this embodiment, referring further to FIG. 6, the slide seat 7 includes a rectangular plate body 71 that has a bottom surface 710 formed with two elongate slide rails 711 engaging slidably and respectively the slide slots 51 in the top surface 50 of the base 5, and two sides 711 opposite to each other in the first direction (X), and two clamp units formed respectively on the sides 711 of the plate body 71. Each clamp unit includes two inverted L-shaped plates 72 opposite to each other in the second direction (Y).

The cloth-holding frame unit 4′ is adapted for holding the piece of cloth 10 thereon, and is mounted on the slide seat 7. In this embodiment, the cloth-holding frame unit 4′ has a configuration similar to that of the cloth-holding frame unit 4 of the first preferred embodiment except that the outer frame 41′ further has two wings 410 extending respectively and outwardly from two sides of the bottom frame portion 412 of the outer frame 41′ that are opposite to each other in the first direction (X). Each wing 410 is clamped between the two inverted L-shaped plates 72 of a corresponding clamp unit and the plate body 71 of the slide seat 7, as shown in FIG. 5.

The coloring unit 62 is operable so as to spray a coloring material onto the piece of cloth 10, thereby printing the picture onto the piece of cloth 10 with the coloring material sprayed from the coloring unit 62.

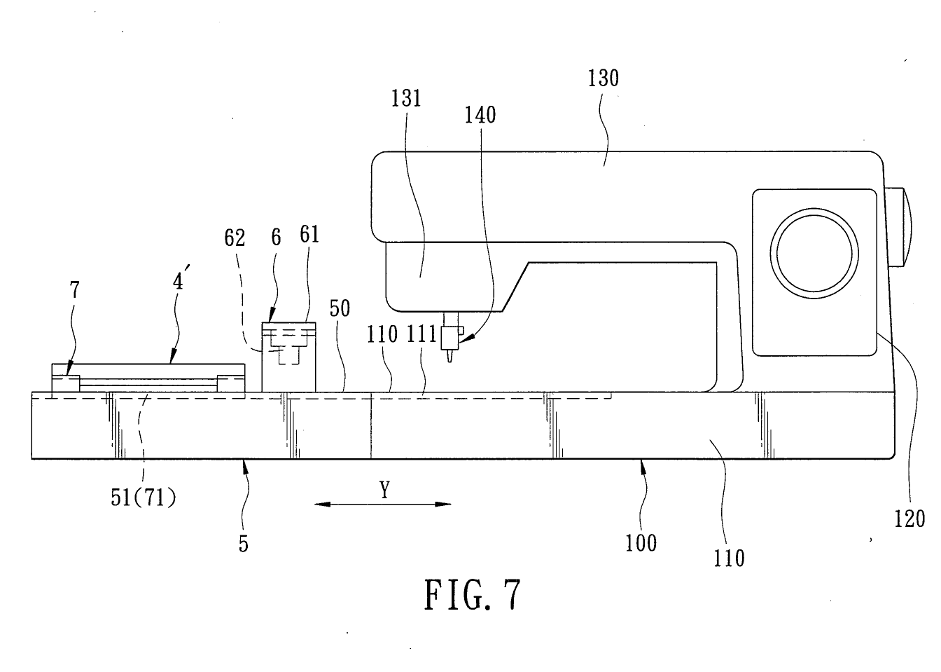

Referring further to FIG. 7, the second preferred embodiment of the device can also be incorporated with an embroidering machine that includes a housing unit 100 and a stitching unit 140. The housing unit 100 includes a bed portion 110 connected to the base 5 and having a top surface 110 co-planar with the top surface 50 of the base 5, an upright column portion 120 extending upwardly from the top surface 110 of the bed portion 110 and having a top end, and an arm portion 130 extending laterally from the top end of the column portion 120 to confront the bed portion 110 and having a head 131 disposed above the bed portion 110. The stitching unit 140 is mounted on the head 131 of the arm portion 130 of the housing unit 100. In this embodiment, the top surface 110 of the bed portion 110 of the housing unit 100 is formed with two parallel slide slots 111 extending in the second direction (Y) and aligned respectively with the slide slots 51 in the base 5.

In use, the slide seat 7 is operable so as to move in the second direction (Y) within one of a printing area, where the slide seat 7 is disposed on the top surface 50 of the base 5, and a stitching area, where the slide seat 7 is disposed on the bed portion 110 of the housing unit 100 and below the stitching unit 140. During printing operation, the coloring unit 62 is operated as described above while the slide seat 7 is disposed in the printing area. After the printing operation, the slide seat 7 is moved from the printing area into the stitching area. Thereafter, the stitching unit 140 is operable so as to perform embroidering operation on the piece of cloth 10 held on the cloth-holding frame unit 4′ and printed with the picture thereon. As a result, an assembly of the device of this invention and the embroidering machine can successively carry out the printing and stitching operations for the piece of cloth 10, thereby resulting in convenience during use.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A device for printing a picture onto a piece of cloth, comprising:
a base having a top surface formed with a receiving groove;
a cover connected pivotally to said base, disposed on said top surface of said base for covering said receiving groove, and configured with an inner accommodating space in spatial communication with said receiving groove in said base;
a cloth-holding frame unit adapted for holding the piece of cloth thereon, and mounted fittingly and detachably in said receiving groove in said base, said cloth-holding frame unit having an outer frame disposed in said receiving groove in said top surface of said base, a looped inner frame disposed on and surrounded by said outer frame, and a lock bolt for locking said outer frame on said looped inner frame such that the piece of cloth is held tensionally between said looped inner frame and said outer frame; and
a coloring unit mounted on said cover, disposed movably in said inner accommodating space in said cover and above the piece of cloth, and operable so as to spray a coloring material onto the piece of cloth, thereby printing the picture onto the piece of cloth with the coloring material sprayed from said coloring unit.

2. The device as claimed in claim 1, wherein:
said outer frame of said cloth-holding frame unit is L-shaped in cross section, and has a looped bottom frame portion, and an open surrounding frame portion extending upwardly from a periphery of said looped bottom frame portion and having opposite ends separated from each other, and two extensions extending respectively from said opposite ends and formed respectively with a through hole and a threaded hole, said lock bolt extending through said through hole and engaging said threaded hole; and
said looped inner frame of said cloth-holding frame unit is L-shaped in cross section, and has a looped bottom frame portion disposed on said looped bottom frame portion of said outer frame, and a looped surrounding frame portion extending upwardly from a periphery of said looped surrounding frame portion of said looped inner frame and surrounded by said open surrounding frame portion of said outer frame.

3. A device for printing a picture onto a piece of cloth, comprising:
a base having a top surface;
a coloring mechanism mounted on said top surface of said base, and including a coloring unit disposed above said top surface of said base and movable relative to said base in a first direction;
a slide seat mounted on said top surface of said base, and movable relative to said base in a second direction perpendicular to the first direction; and
a cloth-holding frame unit adapted for holding the piece of cloth thereon, mounted on said slide seat, and disposed below said coloring unit, said cloth-holding frame unit having an outer frame mounted on said slide seat, a looped inner frame disposed on and surrounded by said outer frame, and a lock bolt for locking said outer frame on said looped inner frame such that the piece of cloth is held tensionally between said looped inner frame and said outer frame;
wherein said coloring unit is operable so as to spray a coloring material onto the piece of cloth, thereby printing the picture onto the piece of cloth with the coloring material sprayed from said coloring unit.

4. The device as claimed in claim 3, wherein:
said outer frame of said cloth-holding frame unit is L-shaped in cross section, and has a looped bottom frame portion, and an open surrounding frame portion extending upwardly from a periphery of said looped bottom frame portion and having opposite ends separated from each other, and two extensions extending respectively from said opposite ends and formed respectively with a through hole and a threaded hole, said lock bolt extending through said through hole and engaging said threaded hole; and
said looped inner frame of said cloth-holding frame unit is L-shaped in cross section, and has a looped bottom frame portion disposed on said looped bottom frame portion of said outer frame, and a looped surrounding frame portion extending upwardly from a periphery of said looped surrounding frame portion of said looped inner frame and surrounded by said open surrounding frame portion of said outer frame.

5. The device as claimed in claim 4, wherein:
said top surface of said base is formed with two parallel slide slots extending in the second direction;
said outer frame of said cloth-holding frame unit further has two wings extending respectively and outwardly from two sides of said bottom frame portion of said outer frame that are opposite to each other in the first direction; and
said slide seat includes a rectangular plate body that has a bottom surface formed with two elongate slide rails engaging slidably and respectively said slide slots in said top surface of said base, and two sides opposite to each other in the first direction, and two clamp units formed respectively on said sides of said plate body and clamping respectively said wings of said outer frame of said cloth-holding frame unit.

6. The device as claimed in claim 5, wherein each of said clamp units includes two inverted L-shaped plates opposite to each other in the second direction.

7. An embroidering machine comprising:
a housing unit including a bed portion having a top surface, an upright column portion extending upwardly from said top surface of said bed portion and having a top end, and an arm portion extending laterally from said top end of said column portion to confront said bed portion and having a head disposed above said bed portion;
a stitching unit mounted on said head of said arm portion of said housing unit; and
a device for printing a picture onto a piece of cloth, said device including
a base connected to said bed portion of said housing unit and having a top surface co-planar with said top surface of said bed portion of said housing unit,
a coloring mechanism mounted on said top surface of said base, and including a coloring unit disposed above said top surface of said base and movable relative to said base in a first direction,
a slide seat mounted movably on said top surface of said base and said top surface of said bed portion of said housing unit and operable so as to move in a second direction perpendicular to the first direction within one of a printing area, where said slide seat is disposed on said top surface of said base, and a stitching area, where said slide seat is disposed on said bed portion of said housing unit and below said stitching unit, and
a cloth-holding frame unit adapted for holding the piece of cloth thereon, mounted on said slide seat, and disposed below said coloring unit, said cloth-holding frame unit having an outer frame mounted on said slide seat, a looped inner frame disposed on and surrounded by said outer frame, and a lock bolt for locking said outer frame on said looped inner frame such that the piece of cloth is held tensionally between said looped inner frame and said outer frame;
wherein said coloring unit is operable so as to spray a coloring material onto the piece of cloth when said slide seat is disposed in the printing area, thereby printing the picture onto the piece of cloth with the coloring material sprayed from said coloring unit; and
wherein said stitching unit is operable so as to perform embroidery operation on the piece of cloth held on said cloth-holding frame unit and printed with the picture thereon after said slide seat is moved from the printing area into the stitching area.

8. The embroidering machine as claimed in claim 7, wherein:
said outer frame of said cloth-holding frame unit is L-shaped in cross section, and has a looped bottom frame portion, and an open surrounding frame portion extending upwardly from a periphery of said looped bottom frame portion and having opposite ends separated from each other, and two extensions extending respectively from said opposite ends and formed respectively with a through hole and a threaded hole, said lock bolt extending through said through hole and engaging said threaded hole; and
said looped inner frame of said cloth-holding frame unit is L-shaped in cross section, and has a looped bottom frame portion disposed on said looped bottom frame portion of said outer frame, and a looped surrounding frame portion extending upwardly from a periphery of said looped surrounding frame portion of said looped inner frame and surrounded by said open surrounding frame portion of said outer frame.

9. The embroidering machine as claimed in claim 8, wherein:
said top surface of said bed portion of said housing unit is formed with two parallel first slide slots extending in the second direction;
said top surface of said base is formed with two parallel second slide slots extending in the second direction and aligned respectively with said first slide slots in said top surface of said bed portion of said housing unit;
said outer frame of said cloth-holding frame further has two wings extending respectively and outwardly from two sides of said bottom frame portion that are opposite to each other in the first direction; and
said slide seat includes a rectangular plate body that has a bottom surface formed with two elongate slide rails each engaging slidably at least one of a corresponding one of said first slide slots in said top surface of said bed portion of said housing unit and a corresponding one of said second slide slots in said top surface of said base, and two ends opposite to each other in the first direction, and two clamp units that are formed respectively on said ends of said plate body and clamping respectively said wings of said outer frame.

10. The device as claimed in claim 9, wherein each of said clamp units includes two inverted L-shaped plates opposite to each other in the second direction.
